(19) United States
(12) Patent Application Publication
(10) Pub. No.: US 2002/0039195 A1
(43) Pub. Date: Apr. 4, 2002

(54) Image forming apparatus and method

(76) Inventor: Kiyoshi Miyake, Mobile, AL (US)

Correspondence Address: Platon N. Mandros, BURNS, DOANE, SWECKER & MATHIS, L.L.P., P.O. Box 1404, Alexandria, VA, 22313-1404, US

(21) Appl. No.: 09/934,480

(22) Filed: Aug. 23, 2001

(30) Foreign Application Priority Data
Sep. 29, 2000 (JP) 2000-300365

(51) Int. Cl. B41J 1/00; G06F 15/00

(52) U.S. Cl. 358/1.15

(57) ABSTRACT

A multipurpose apparatus having a plurality of functions such as printer, fax, copier and the like, further having a plurality of controllers for controlling image data of the respective functions, wherein each controller requests printing of the image data by the printer unit after development is completed for the received print job.

### RELATED APPLICATION

This application is based on Patent Application No. 2000-300365 filed in Japan, the entire content of which is hereby incorporated by reference.

### BACKGROUND OF THE INVENTION

1. Field of the Invention

The present invention relates to printing control in a multipurpose apparatus providing a plurality of functions such as printer, fax, copier and the like in a single apparatus.

2. Description of the Related Art

A multipurpose device can use a plurality of functions such as printer, fax, copier and the like in a single apparatus. A plurality of controllers in the multipurpose apparatus corresponding to a printer, fax, copier and the like respectively control a single engine for image formation.

In a multipurpose apparatus wherein a single engine is controlled by a plurality of controllers, when an optional controller operating independently once has exclusive use of the print engine, other controllers cannot start a printing operation until the original printing process is completed and exclusive use ends. For example, when a print job of a plurality of pages is processed by the printer controller, the printer controller has exclusive use of the engine from the moment a first page is received and the printing process is enabled. Even when much time is required for receiving the remaining pages and development processing, the controller maintains exclusive use of the engine until print processing of all pages is completed regardless even though the engine cannot execute print processing during this time. Accordingly, cancellation of the exclusive use by the controller which has exclusive use of the engine is awaited even when another controller receives data and is capable of print processing during this time.

Printing does not start when printing conditions on the controller side do not match the engine structure (e.g., when the specified paper size is not loaded in a cassette). As a result, although exclusive use of the engine has started, the engine is stopped due to error, and the engine remains stopped and the exclusive use condition continues until the user cancels the error. Japanese Laid-Open Patent Application No. H11-305963 proposes that, when a next job is received during processing of a current job, the job priority ranking may be replaced according to user-defined conditions, such that the original job is has a later priority ranking. Furthermore, Japanese Laid-Open Patent Application No. H6-297815 proposes that, in a printer provided with a plurality of ports, job priority ranking may be replaced by the number of pages of the job when the job is received, and that the priority ranking may be replaced the port exclusive use time for each receiving port. However, in either case the job priority ranking is improved within a single controller, and neither case improves the relationship among a plurality of controllers operating simultaneously in a multipurpose apparatus.

### SUMMARY OF THE INVENTION

An object of the present invention is to eliminate the previously described disadvantages.

A further object of the present invention is to improve productivity in multipurpose apparatuses wherein a plurality of controllers control a single engine.

These and other objects are attained by an image forming apparatus comprising a printer for printing based on received print data, and a plurality of controllers for respectively receiving a print job, and generating image data by image development of the received print job (each controller requests the engine to start printing after complete image development of a received print job). These objects of the present invention are further attained by an image data processing method comprising a step of receiving a print job, a step of generating print data, and a step of requesting the printer to start printing after complete image development of the received print job.

The objects are further attained by a control method for controlling an image forming system having a plurality of controllers which generate print data by image development of received print job, and transmit the generated print data to a single printer, the control method comprising the steps of:

each controller issuing a print request to the printer after complete development of a received print job;

storing each print request sequentially; and

the print executing printing in the stored print request sequence.

The invention itself, together with further objects and attendant advantages will be best understood by reference to the following detailed description taken in conjunction with the accompanying drawings.

### BRIEF DESCRIPTION OF THE DRAWINGS

FIG. 1 shows the structure of a multipurpose apparatus (first embodiment);

FIG. 2 is a block diagram of a controller;

FIG. 3 is a flow chart of the control of the data receiver;

FIG. 4 is a flow chart of the control of the image developer;

FIG. 5 is a flow chart of the control of the image transmitter;

FIG. 6 shows the structure of a multipurpose apparatus (second embodiment);

FIG. 7 is a block diagram of a controller;

FIG. 8 is a flow chart of the control of the image transmitter; and

FIG. 9 is a flow chart of the control of the job manager.

In the following description, like parts are designated by like reference numbers throughout the several drawings.

### DESCRIPTION OF THE PREFERRED EMBODIMENTS

The embodiments of the present invention are described hereinafter with reference to the accompanying drawings. In the drawings, like parts are designated by like reference numbers.

The image forming apparatus of the embodiments is a multipurpose apparatus comprising an engine used in common by a plurality of controllers corresponding to a printer, fax, copier and the like. Total productivity is improved by reducing as much as possible the engine exclusive use time of each controller. For this reason each controller subjects a series of reception data to image development, and thereafter transmits the developed development data to the engine. This data transmission control maximizes the total system of the multipurpose apparatus not by replacing the top priority sequence by job content, but rather by more efficiently operating the engine (ideally, by normally maximizing the printing speed) by monitoring the exclusive use module of the engine.

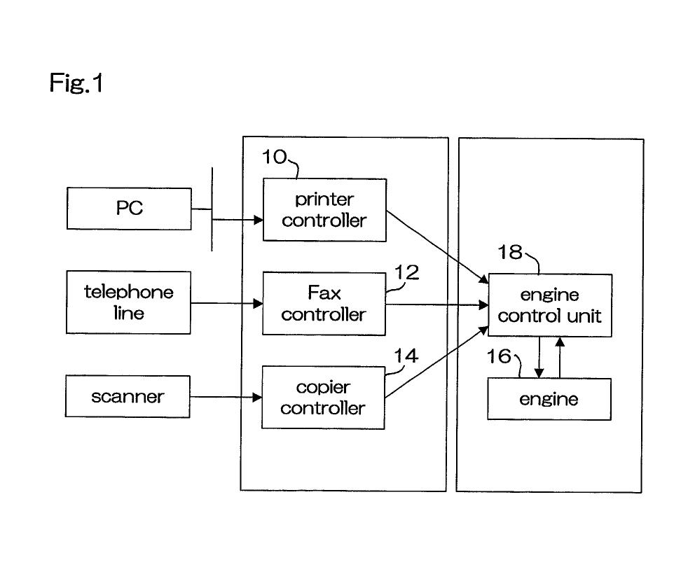

FIG. 1 shows the structure of a multipurpose apparatus of a first embodiment. This multipurpose apparatus is provided with a plurality of controllers, i.e., printer controller 10 for receiving and printing print data from a connected computer, fax controller 12 for receiving and printing fax data from a telephone line, and copier controller 14 for printing data read by a scanner. The plurality of controllers 10, 12, 14 share common use of the engine. The engine comprises a print engine 16 for executing image formation, and a control unit 18 for controlling the print engine 16 receiving raster image data from a controller.

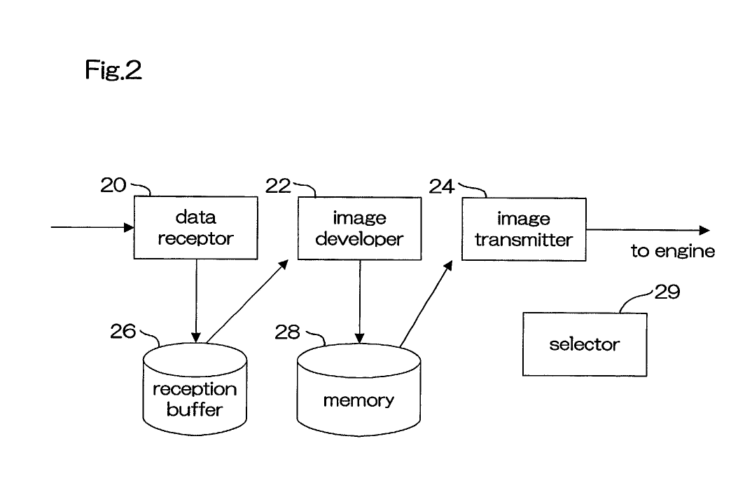

As shown in FIG. 2, each controller 10, 12, 14 is provided with a data receptor 20, image developer 22, image transmitter 24, reception buffer 26 as a memory for storing image data, and memory 28 for storing developed data. The data receiver 20 stores reception data in reception buffer 26. The image developer 22 acquires data from reception buffer 26, develops intermediate data, and stores the intermediate data in the developed data storage memory 28. The image transmitter 24 transmits developed image data stored in the developed data storage memory 28 to the engine control unit 18. The data receiver 20, image developer 22, and image transmitter 24 operate independently of one another.

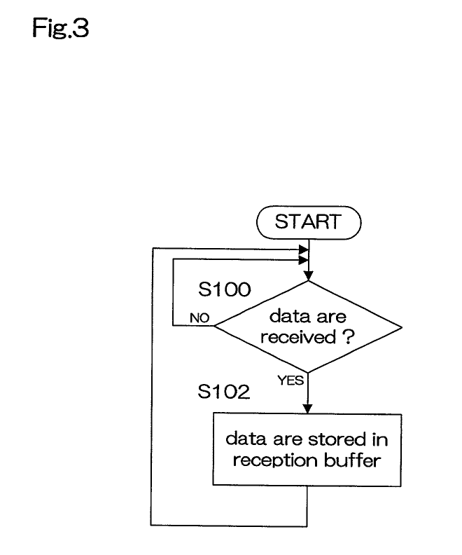

FIG. 3 shows the flow of the control of the data receiver 20. In the data receiver 20, when reception data are received from a host device such as a computer, telephone line, scanner or the like (S100), the data are sequentially stored in reception buffer 26 (S102).

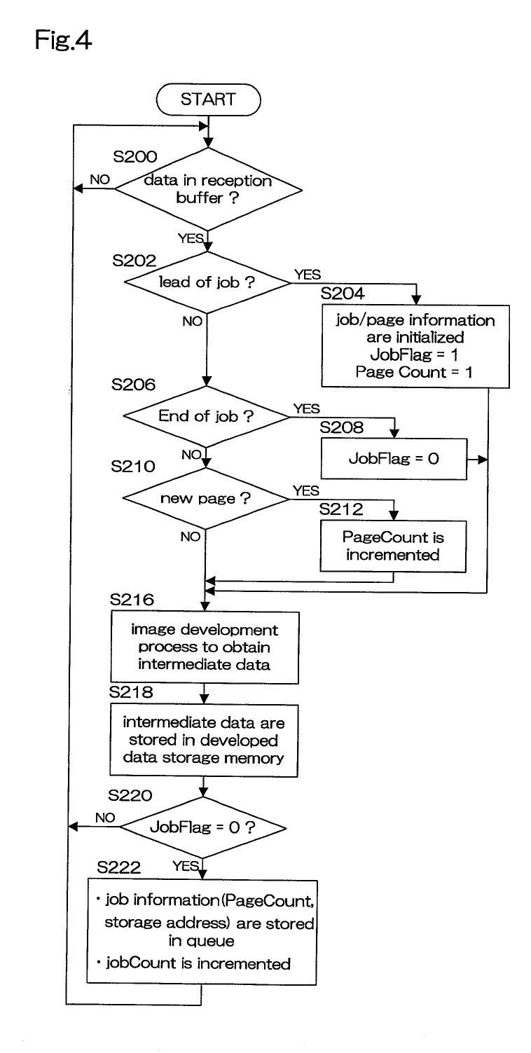

FIG. 4 shows the flow of the control of the image developer 22. In the image developer 22, image data stored in the reception buffer 26 are processed in discrete jobs. First, when there are data stored in the reception buffer 26 (S200: YES), if it is a lead job (S202: YES), the job/page information are initialized (S204), and when the job ends (S206: YES), the job flag is set at [0] (S208), and if there is a new page (S210: YES), the page count is incremented (S212). Then, the reception data stored in the reception buffer 26 are subjected to development processing to obtain intermediate data (S216), which are stored in the developed data storage memory (S218). Then, the total page number including job data and storage address destination are managed for each job data end (S220: YES)and maintained as job information, and the job count is increased as the stored job counter (S222).

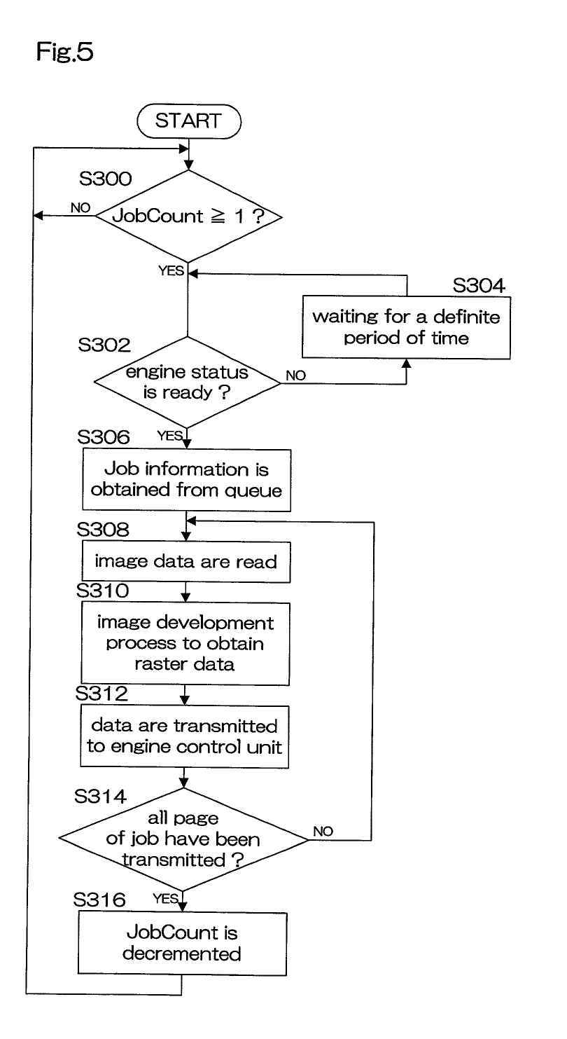

FIG. 5 shows the flow of the control of the image transmitter 24. In the image developer 24, when the job count added for each accumulation of job data developed by the image developer 22 attains [1] or more (S300: YES), the engine condition is confirmed at regular intervals (S302, S304). If an error is not generated in the engine, or if another controller does not have exclusive use of the engine, the job information generated by the image developer is obtained from the queue (S306). Then, the image data are read (S308), and developed to raster data of the intermediate data image (S310), and transmitted to the engine control unit 18 (S312). This process is repeated for each page until all pages of the job have been transmitted (S314: YES), and during this time the engine is under an exclusive use condition. When transmission of all pages of job data ends, the exclusive use of the engine is cancelled, and the job count is subtracted (S316).

The “intermediate data development process” (step S216 in FIG. 4) executed by the image developer 22 reduces the load of raster development processing before development by realizing a transfer speed which ensure as far as possible the engine maximum printing speed (pages/min) even when the image transmitter 24 transmits an image to the engine control unit 18 in parallel with the raster (bitmap) development process (step S310 in FIG. 5). In this way after a series of reception data are subjected to image development, the data are transmitted to the engine such that the developed page batch can be printed by the engine at the maximum print speed. The development level is dependent on the maximum print speed (pages/min) of the engine 16, and the image processing power of the controller. Since the raster development power of the image transmitter 24 is high when a high performance controller is used, the development process to produce intermediate data can be reduced, intermediate data can be stored in compressed form, and memory is conserved. Of course, when a low performance controller is used, the image developer 22 may develop intermediate data to raster state in the development process, and the image data may be sent undivided to the engine without the image transmitter 24 executing a new development process.

In the present embodiment, printing does not start until job reception and development ends, however, naturally, in the case of a controller which does not maintain adequate memory there may be instances wherein all pages of a job cannot be stored in memory at one time. In this case, dividing the pages of a stored job once be beforehand may be considered, and after printing once, the remaining pages may be similarly received, developed, and printed as a new job. That is, after image development of a series of reception data (i.e. amount of data or pages can be stored at a time in a memory provided in an image processing controller), the developed page batch data can be sent to the engine in a form normally printable by the engine at maximum printing speed.

The image transfer determination (print start) such as engine status confirmation and the like in the image transmitter 24 of the first embodiment includes not only confirmation of engine status, but also an image transfer (print start) determination to confirm whether or not print job printing conditions are satisfied by the current engine structure. For example, when a specific paper tray is specified (e.g., tray 2; not shown) and it is unknown which tray accommodates the specified size (e.g., A4) in the current engine structure, or when the specified tray (tray 2) is not loaded, for example, standby may continue until the job conditions are satisfied by the engine structure without starting image transfer or exclusive use of the engine even when the engine status is ready. In this way printing productivity of the system is improved without other controllers or a next job enduring a wasteful wait period by stopping a job print operation before it starts when it can be expected that the operation may result in a error stoppage during printing.

At this time, it is desirable to provide a combination of functions to alert a user to the error condition via some type of warning means, and demand a modification of engine structure or modification of job conditions. Furthermore, when the image transmitter is constructed so as to manage information of a plurality of jobs, an image transfer may be started for a next job prepared under image development print conditions while a present print job for which print conditions cannot be prepared is interrupted.

According to the controls described above, each controller 10, 12, 14 transmitting image data to the engine control unit 18 executes an image development process after receiving the job data, and when all pages of the job are prepared printing can start at the maximum print speed of the engine, and exclusive use of the engine begins. Then, the engine exclusive use time of the controllers 10, 12, 14 is minimized since the engine exclusive use condition is cancelled after each controller 10, 12, 14 completes the image transmission process of all pages. A plurality of controllers processing simultaneously in parallel avoids having other controllers wastefully waiting while one controller has exclusive use of the engine. This arrangement greatly improves the printing productivity of the system.

Considered below are a case wherein it is desired that each controller has a print priority ranking during processing by the image developer 22 and image transmitter 24, and a case wherein a copier controller 14 communicates with a scanner with a high-performance ADF (auto document feeder) attachment to guarantee image transmission to the engine at maximum printing speed before reception of all pages of a job. That is, a selector 29 is provided to allow a user to select for each controller either a method wherein an image transmission process to the engine is not started until job reception is complete and image development ends for all pages as in the present embodiment, or a method wherein if an image of one page can be developed after job reception, the image transmission process to the engine is started and the controller has exclusive use of the engine as in conventional arrangements. When the copier controller 14 guarantees the image transmission at maximum engine print speed beforehand, data transmission to the engine can be started at an early stage without waiting for reception of all pages, and the time until print completion is reduced.

The multipurpose apparatus of a second embodiment is described below.

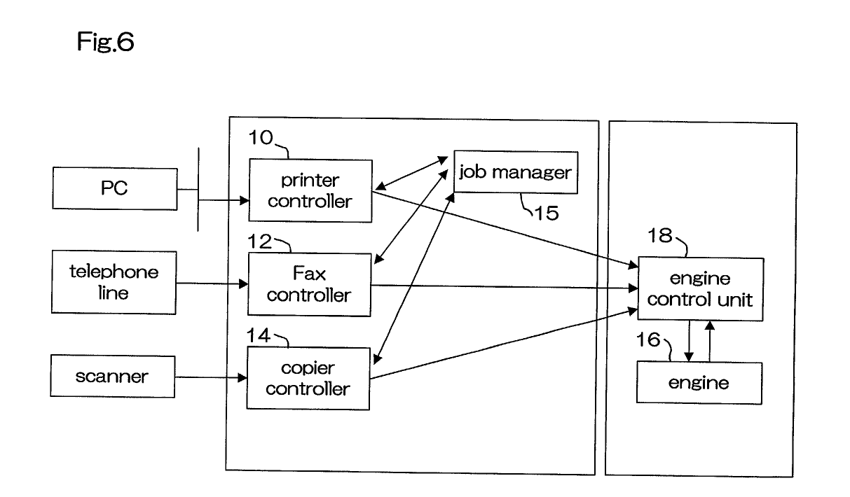

FIG. 6 shows the structure of a multipurpose apparatus of the second embodiment. The multipurpose apparatus of the second embodiment differs from the multipurpose apparatus of the first embodiment (FIG. 1) in that a job manager 15 is provided. The job manager 15 batch manages image transmission start decision to the engine and engine status confirmation performed by each controller in the multipurpose apparatus of the first embodiment after received job development ends, and schedules all jobs.

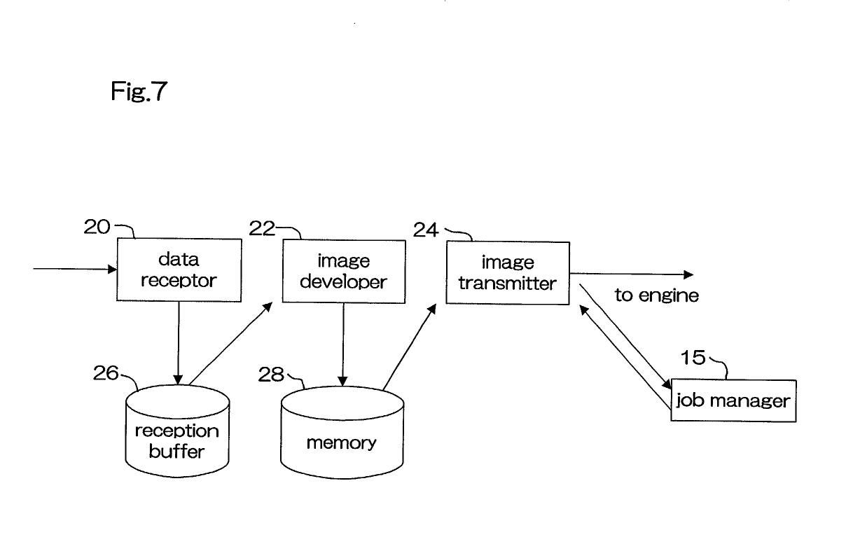

As shown in FIG. 7, each controller 10, 12, 14 has a receiver 20, image developer 22, and image transmitter 24 similar to the multipurpose apparatus of the first embodiment (FIG. 2), and the receiver 20 and image developer 22 perform controls (FIGS. 3 and 4) similar to the controls of the first embodiment. The job manager 15 receives job information notification and registration from the image transmitter 24, and sends image data to the image transmitter 24.

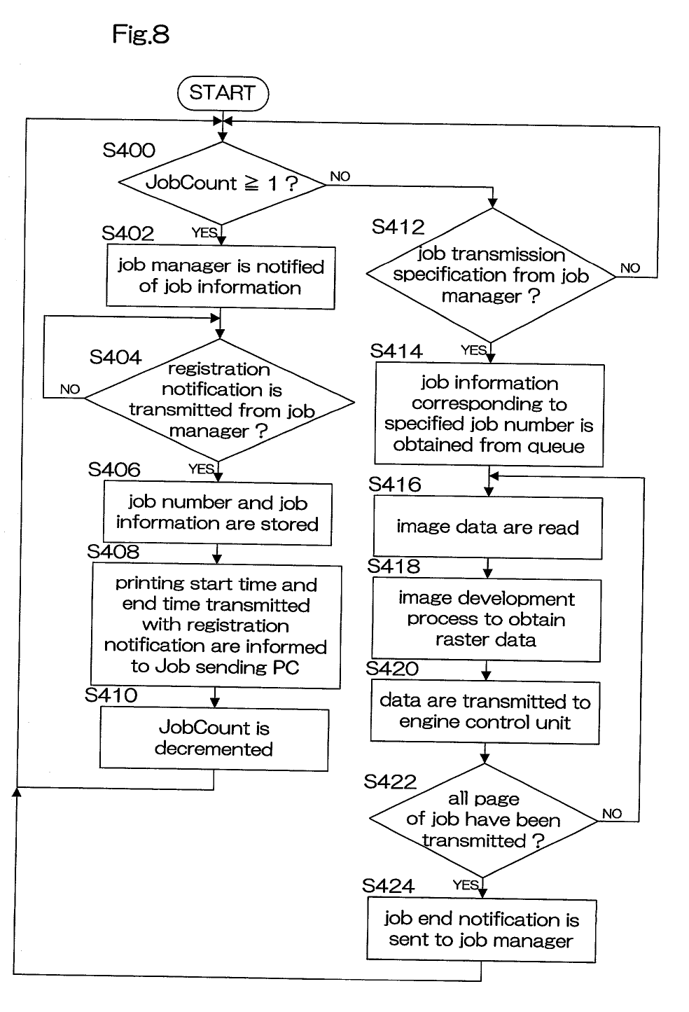

FIG. 8 shows the flow of the control of the image transmitter 24. When the job count added for each accumulation of the job data developed by the image developer 22 attains [1] or more, (S400: YES), the job manager 15 is notified of job information such as paper size, total number of pages and the like (S402). In this way jobs are registered in a queue (waiting job list) on the job manager 15 side, and a job number appended to the job information during registration, the predicted wait time from the current time to the start of printing of this job (print start time), and the predicted wait time from the current time to the end of printing of this job (print end time) are transmitted as registration notification information (S404). The image transmitter 24 matches and maintains the job number and job information (S406), and notifies the user of the predicted printing start time and end time (S408). The job data sending computer or front panel or the like may be considered as the notification means. After the job information registration by the job manager 15 ends, the job count is subtracted (S410).

Regarding jobs previously registered in the job manager 15, when a job transmission specification is received from the job manager 15 at the jobs actual print start time (S412: YES), the job information is specified from the job number sent together with the specification (S414), image data are read based on the job information (S416), developed to raster data of the intermediate data image (S418), and sent to the engine control unit 18 (S420). This process is repeated for each page until all pages of the job have been sent (S422: YES), and during this process the engine is under exclusive use condition. When sending of job data completely ends, a job transmission end (job end) notification is sent to the job manager 15 (S424). In this way exclusive use of the engine is cancelled.

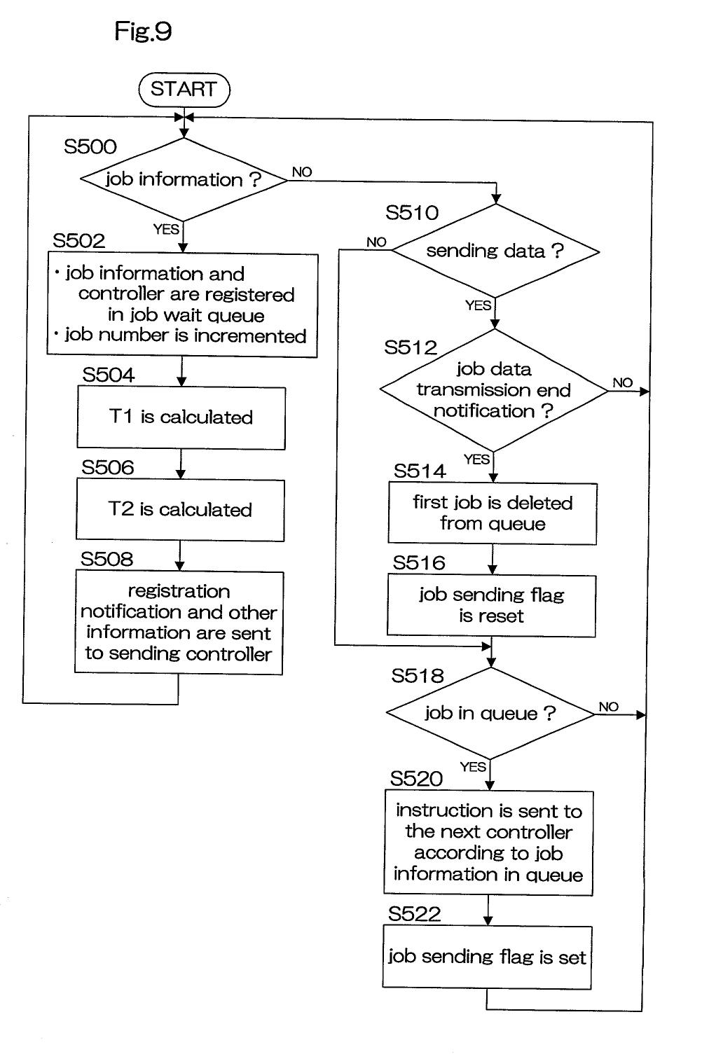

FIG. 9 shows the flow of the control of the job manager 15. When the job manager 15 receives notification of job information from an optional controller (S500: YES), the job information and transmission origin controller are registered in the job wait queue, a job number is added for management, and these aspects are managed (S502). The job number is information unified management of registered job W information from the optional controller, and is added one by one at registration. Then, the time (T1) required for printing the job is calculated from the paper size and total page number specified in the job information, and the maximum print speed of the engine when printing this size and number of pages (S504). In a similar method, the total print time of the jobs previously registered in the job wait queue is calculated, and the time from the start of printing of the jobs currently printing until the present is subtracted to calculate the wait time (T2) until the printing ends for the registered jobs (S506). In this way the job number, print start wait time (T2−T1), and print end wait time (T2) are sent to the sending controller as registration notification (S508). Then, the process returns to step S500.

Thereafter, the job manager 15 internally manages a job sending flag specifying whether or not the current optional controller is currently sending image data. If the job sending flag is not set (S510: NO), and if the job is in the job wait queue (S518: YES), a job transmission start specification is sent to the controller from which the job information originates to start printing the lead job (S520), and the job send flag is set (S522). If a job is currently sending (S510: YES), when a job data transmission end notification is received from the controller (S512: YES), the lead job information is removed from the job wait queue (S514), and the job send flag is reset (S516). When another job is present in the job wait queue after the job send flag has been reset (S518: YES), the corresponding controller is notified of the next job send specification (S520), and again the job send flag is set (S522), and the routine returns to step S500.

These controls reduce the work of synchronous engine status management and image transmission start decisions by each controller compared to the first embodiment, and notifies a user of the print start time and end time of the received job. In this way the usability of the system is improved for the user.

According to the previously described embodiments, the maximum printing productivity of the system is improved by eliminating the wait for print processing by other controllers when an optional controller gains wasteful exclusive use of the engine during job reception, image development or the like.

According to the previously described embodiments, printing productivity of the system is improved without other controllers or a next job enduring a wasteful wait period by stopping a job print operation before it starts when it can be expected that the operation may result in a error stoppage during printing.

According to the previously described embodiments, the print start time and end time are more accurately calculated and a user notified from the current state of the multipurpose apparatus relative to jobs received beforehand.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image forming apparatus comprising:
a printing portion for printing based on received print data; and
a plurality of controllers for respectively receiving a print job, and generating image data by image development of the received print job, each controller requesting the printing portion to start printing after complete image development of a received print job.

2. An image forming apparatus as claimed in claim 1, further comprising:
a job control portion for receiving and storing the printing request, and instructing the printing portion to start in sequence that the job control portion receives the printing request.

3. An image forming apparatus as claimed in claim 2, wherein the job control portion informs a user who sends a print job of printing information.

4. An image forming apparatus as claimed in claim 3, wherein the printing information is a time to start printing.

5. An image forming apparatus as claimed in claim 3, wherein the printing information is a time to finish printing.

6. An image forming apparatus as claimed in claim 1, further comprising:
a selector for selecting a way of requesting the printing portion to start printing between after complete image development of a received print job and after complete image development of one page of a received print job.

7. A control method for controlling an image forming system having a plurality of controllers which generate print data by image development of received print job, and transmit the generated print data to a printing portion, the control method comprising the steps of:
each controller issuing a print request to the printing portion after complete development of a received print job;
storing each print request sequentially; and
having the printing portion print in the stored print request sequence.

8. An image data processing method comprising the steps of:
receiving a print job;
developing the print job and generating print data; and
requesting a printing portion to start printing after complete image development of the received print job.

9. A program product comprising the steps of:
receiving a print job;
developing the print job and generating print data; and
requesting a printing portion to start printing after complete image development of the received print job.
